(19) United States
(12) Patent Application Publication
(10) Pub. No.: US 2026/0087792 A1
(43) Pub. Date: Mar. 26, 2026

(54) SYSTEMS AND METHODS FOR MITIGATING FALSE NEGATIVES IN NEURAL NETWORK-BASED OBJECT DETECTION

(71) Applicant: Booz Allen Hamilton Inc., McLean, VA (US)

(72) Inventors: Bruce Andrew JOHNSON, Marana, AZ (US); Lusine KAMIKYAN, Washougal, WA (US)

(73) Assignee: Booz Allen Hamilton Inc., McLean, VA (US)

(21) Appl. No.: 19/331,720

(22) Filed: Sep. 17, 2025

Related U.S. Application Data
(60) Provisional application No. 63/697,031, filed on Sep. 20, 2024.

(51) Int. Cl. G06V 10/82; G06V 10/20; G06V 10/25

(52) U.S. Cl. CPC G06V 10/82; G06V 10/25; G06V 10/255

(57) ABSTRACT

Embodiments can relate to a computer vision object detection system having a processor with object detector (OD) and a light informed shape analysis (LISA) modules. Upon receiving an image scene, the process can cause the OD module to: to identify an object as an object of interest; identify a region of interest for the object of interest; generate a bounding box encompassing the object of interest and the region of interest; and track movement of the object of interest. When the OD detector drops the bounding box for the object of interest, the processor can cause the LISA module to: extract a region of interest for use as an expected region of interest for the object of interest; extract one or more shape contours of the object of interest for use as a representation of the object of interest; and track movement of the object of interest.

### CROSS-REFERENCE TO RELATED APPLICATIONS

This patent application is related to and claims the benefit of priority of U.S. provisional patent application No. 63/697,031, filed on Sep. 20, 2024, the entire contents of which is incorporated herein by reference.

### FIELD

Embodiments can relate to a computer vision object detection system configured to extract one or more shape contours of one or more shapes and use the same as a representation of an object of interest.

### BACKGROUND INFORMATION

With existing machine learning techniques applied to object recognition, the machine learning system takes training data input, applies a model, and then makes distinctions between the classes of objects within the training set (e.g., items-of-interest or IOIs) and those objects who are not members of the training set. A machine learning model's theory of knowledge produces justified beliefs about the class of a particular IOI by means of using inference to generate a confidence interval deeming a candidate IOI to be a member of the training class. When this inference process works well, a true positive is generated where an IOI exists in the image under examination and its existence is detected and confirmed by the classifier. A false negative occurs when an IOI exists in the image under examination but whose existence is not acknowledged by the classifier.

Neural network (NN)-based object detectors have become well-established as a means of performing object detection and tracking. NN-based object detectors place an enormous amount of credibility in the training set to provide the various instantiations and configurations of the objects to be detected and classified. The concept behind NN-based detectors works well in many scenarios, but they are not perfect because there is much that the training set an NN relies upon does not cover. For instance, there are permutations, image noise and/or levels of concealment for a particular object which simply may not exist in the training set; thus, resulting in a false negative when a novel instance of an object to be detected is encountered.

### SUMMARY

An exemplary embodiment can relate to a computer vision object detection system. The system can include a processor. The processor can include a Neural Network based object detector (NN-detector) module and a light informed shape analysis (LISA) module. The processor can be configured to receive an image scene. The processor can be configured to cause the NN-detector module to perform one or more functions disclosed herein. The processor can be configured to cause the NN-detector module to scan the image scene to identify an object as an object of interest. The processor can be configured to cause the NN-detector module to identify a region of interest for the object of interest. The processor can be configured to cause the NN-detector module to generate a bounding box that encompasses the object of interest and the region of interest. The processor can be configured to cause the NN-detector module to track position or movement of the object of interest. When the NN-detector drops the bounding box for the object of interest, the processor can be configured to cause the LISA module to extract a region of interest for use as an expected region of interest for the object of interest. The processor can be configured to cause the LISA module to extract one or more shape contours of the object of interest for use as a representation of the object of interest. The processor can be configured to cause the LISA module to track position or movement of the object of interest.

An exemplary embodiment can relate to a computer vision object detection method. The method can involve receiving an image scene. The method can involve performing one or more functions by a Neural Network based object detector (NN-detector) module. The method can involve scanning, by the NN-detector module, the image scene to identify an object as an object of interest. The method can involve identifying, by the NN-detector module, a region of interest for the object of interest. The method can involve generating, by the NN-detector module, a bounding box that encompasses the object of interest and the region of interest. The method can involve tracking, by the NN-detector module, position or movement of the object of interest. When the bounding box for the object of interest is dropped, the method can involve performing one or more functions by a light informed shape analysis (LISA) module. The method can involve extracting, by the LISA module, a region of interest for use as an expected region of interest for the object of interest. The method can involve extracting, by the LISA module, one or more shape contours of the object of interest for use as a representation of the object of interest. The method can involve tracking, by the LISA module, position or movement of the object of interest.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 is an exemplary system block diagram;

FIGS. 2A and 2B show an exemplary flow diagram Neural-Net/light informed shape analysis;

FIG. 3 shows a general overview of light informed shape analysis technique;

FIG. 4 shows an exemplary illustration of object detection and tracking via a light informed shape analysis technique even when the object is partially concealed;

FIG. 5 shows an exemplary illustration of object detection and tracking via a light informed shape analysis technique even when the image scene is obtained under noisy conditions; and

FIG. 6 shows an exemplary illustration of object detection and tracking via light informed shape analysis technique even when the object is mostly concealed and when the image scene is obtained under clean (top panel) or noisy (bottom panel) conditions.

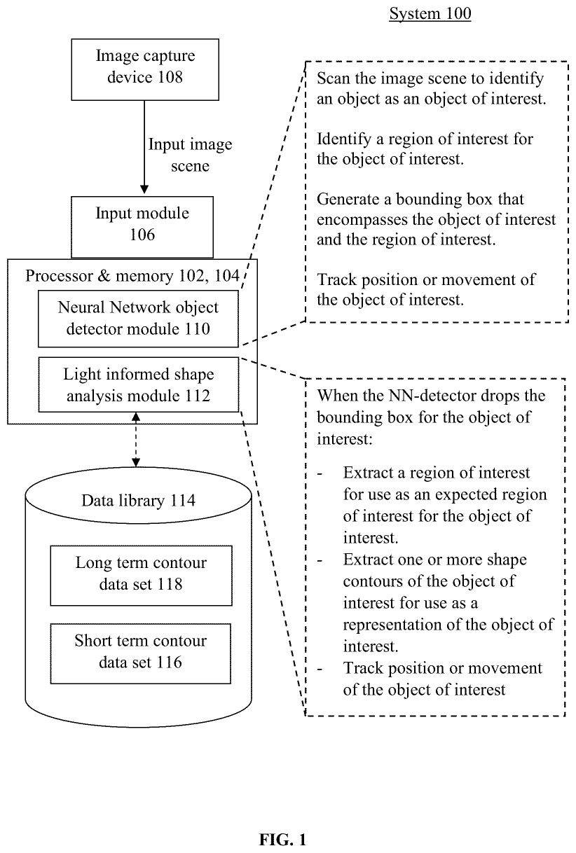

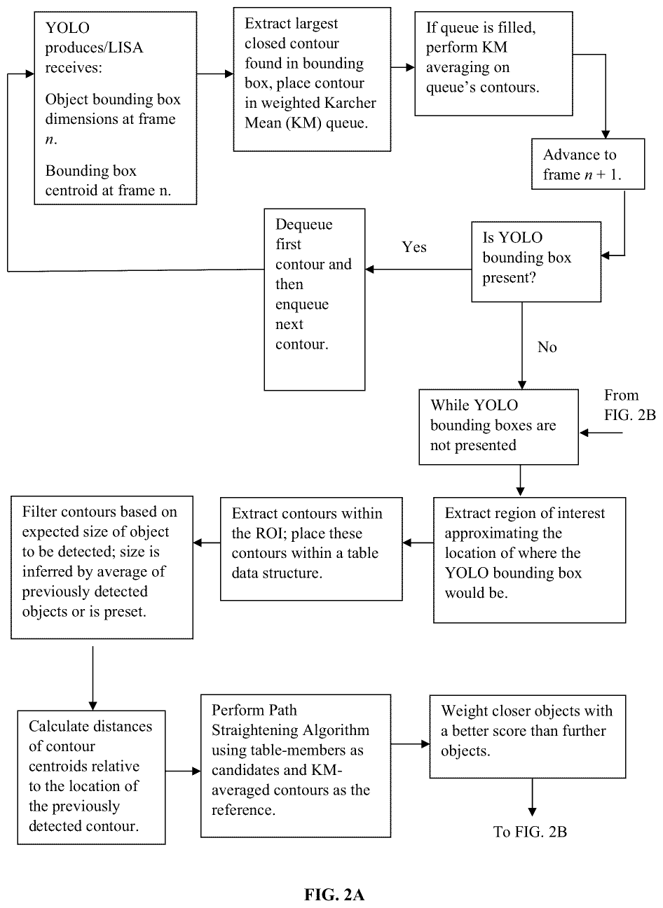

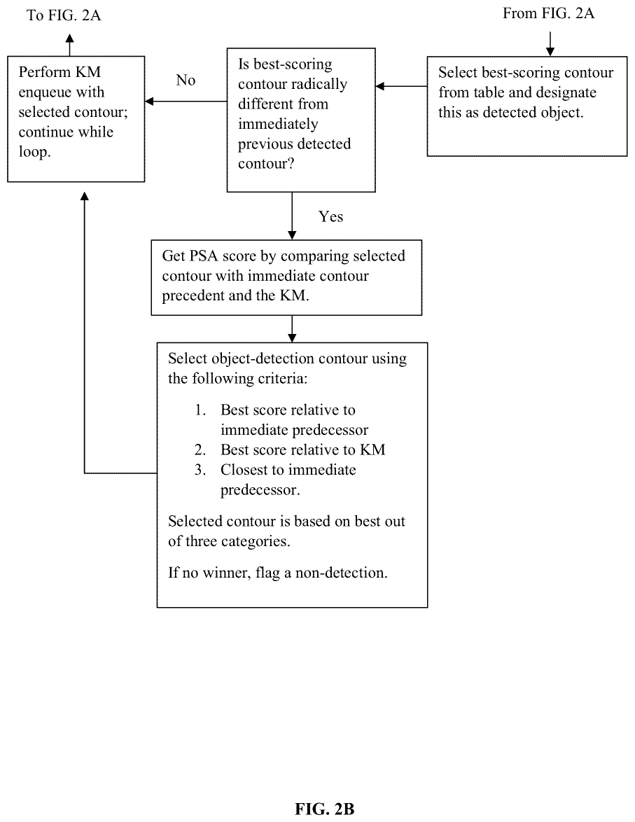

### DETAILED DESCRIPTION

As will be described herein, known Neural Network object detection systems use You Only Live Once (YOLO) techniques for object detection. As a broad overview, YOLO generates a bounding box to define an area of interest around an object of interest which allows a computer vision system to track movement of the object in an image scene that has been identified/classified as an object of interest. For instance, a suspect's (e.g., object of interest) movements can be tracked from image scene(s) using the YOLO technique. YOLO utilizes an inferencing technique with a confidence interval to determine a bounding box for the object of interest. However, if/when an object that was once identifiable/classifiable/trackable becomes only partially visible (e.g., the suspect is hiding behind another object) or is otherwise obscured, undiscernible, blurred, unfocused, pixelated, etc., it can cause the Neural Network object detection classifier to “drop” its bounding box. For instance, if the confidence interval for forming a bounding box is too low (e.g., passes a threshold), the Neural Network object detection classifier will determine that the object is no longer there and therefore remove the bounding box. Without a bounding box, no tracking of the position or movement of the object can be performed. To the credit of the Neural Network object detection classifier, dropping the bounding box is what it should do if the confidence interval is too low. However, this dropping does not account for scenarios when the object is still there but has become only partially visible, obscured, etc.—e.g., known YOLO systems do not account for false negatives.

The techniques disclosed herein can be used in conjunction with a YOLO implemented vison system—e.g., it can be used as a plug-in to augment the YOLO vision system. When a bounding box is dropped, embodiments of the technique can step in to determine whether the object is really no longer in the image scene or that the object has become partially visible, obscured, etc. If it is the later, embodiments of the techniques disclosed herein can facilitate continued object detection and tracking if in fact the object is still in the image scene but is otherwise determined by YOLO to not be there. This can be done by the system extracting contour(s) (e.g., shape contour(s)) from a region(s)/area(s) of the object and use that/those extracted shape contour(s) as a representation (e.g., proxy, substitute, etc.) of the object. The system can also extract an expected area of interest (e.g., an expected bounding box) for the extracted shape contour(s). If/when the YOLO system can re-establish the bounding box, the system can toggle back to the YOLO system for further object detection and tracking. For instance, if a suspect is an object of interest and is being tracked via YOLO, but then partially hides behind a structure to cause the bounding box to be dropped, embodiments of the techniques disclosed herein can extract shape contour(s) of the suspect's shoulder, for example, and use those as proxies for the object. The system can generate a bounding box for the object associated with the extracted shape contours and facilitate continued tracking. Once the suspect reveals themselves again, the YOLO can then re-establish its bounding box, wherein the system can resort back to YOLO techniques for the object tracking.

Embodiments can relate to a computer vision object detection system 100. The system 100 can include one or more processors 102. The system 100 can include one or more memories 104. The processor(s) 102 can be operatively associated with or include the memory (ies) 104. One or more algorithms, models, programming logic, etc. can be stored in the memory 104 as data structure in the form of instructions, and the processor 102 can execute the instructions to implement any of the functions disclosed herein.

The processor can be any of the processors disclosed herein. The processor can be part of or in communication with a machine (logic, one or more components, circuits (e.g., modules), or mechanisms). The processor can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors herein can include any one or combination of a Graphics Processing Unit (GPU), a Field Programmable Gate Array (FPGA), a Central Processing Unit (CPU), etc. The processor can include one or more processing modules. A processing module can be a software or firmware operating module configured to implement any of the method steps disclosed herein. The processing module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. The computer or machine readable medium can be configured to store one or more instructions thereon. The instructions can be in the form of algorithms, program logic, a model, etc. that cause the processor to perform any of the functions described herein.

Any of the memories discussed herein can be computer readable memory configured to store data. The memory can include a volatile or non-volatile, transitory or non-transitory memory, and be embodied as an in-memory, an active memory, a cloud memory, etc. Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor can be in communication with other processors of other devices (e.g., a computer device, a desktop computer, a laptop computer, a computer system, etc.). Any of those other devices can include any of the exemplary processors disclosed herein. Any of the processors can have transceivers or other communication devices/circuitry to facilitate transmission and reception of wireless signals. Any of the processors can include an Application Programming Interface (API) as a software intermediary that allows two applications to talk to each other. Use of an API can allow software of the processor of the system to communicate with software of the processor of the other device(s), if the processor of the system is not the same processor of the device.

Any data transmission between the processor and memory, between the processor and a database, and between the processor and processors of other devices, etc. can be via a pull operation (e.g., the processor can pull the data) or a push operation (e.g., the data can be pushed to the processor). The processor can receive the data in steaming format, or store it in memory before being processed. In addition, embodiments of any of the algorithms, models, etc. disclosed herein can be developed as an application software (an “App”) to be implemented on a processor of a device. The App can be sent via a steaming format, or the App can be sent and stored on a memory associated with or accessed by the device.

As noted herein, the processor can be configured to be a component of, used in combination with, or in communication with another device/system—e.g., this can include the processor being part of the device/system, the device/system being part of the processor, the processor in communication with the device/system, etc. “Being part of” can include being on a same substrate or integrated circuit. For instance, the processor can be a component of, used in combination with, or in communication with a predictive modeling system, a decision support system, an automated control system, etc. The processor can use the model or algorithm or provide the model or algorithm to the device/system to assist with or augment the performance of these devices/systems.

While exemplary embodiments may describe and/or illustrate one processor 102 and one memory 104, it is understood that the system can include any number of processors 102 and memories 104.

The system 100 can include one or more input modules 106. The input module 106 can be configured for receiving an image scene. This can be an image scene captured by one or more image capture devices 108, for example. The input module 106 can include or be a processor having program logic stored in memory associated with the processor for facilitating customization of data pertaining to an event, management of communication between an event capturing apparatus (e.g., an image capture device 108), management of power loads, etc. The input module 106 can also include receiver(s), antenna(s), transmitter(s), etc.

The image capture device 108 can be an optical or digital camera, an optical or digital video recorder, a monitor, etc. It is contemplated for the image capture device 108 to be an optical or digital camera, which can be configured as a charge-coupled device, an active-pixel sensor device, etc. The image capture device 108 can include a processor and associate memory configured for capturing, recording, processing, storing, transmitting, etc. images.

The processor 102 can include one or more Neural Network based object detector (NN-detector) modules 110. The NN-detector module 110 can be configured to compare one or more objects from the image scene to classify the object as an object of interest. While the NN-detector module 110 is described and illustrated herein as a neural net object classifier module, it can be a decision tree classifier module, KNN classifier module, logistic regression classifier module, etc. The NN-detector module 110 can implement one or more classification techniques (e.g., supervised, unsupervised, neural net, decision tree, KNN, logistic regression, naïve bayes, random forest, etc.) and apply it/them to a trained dataset. It is contemplated for the classification technique to be a YOLO classification technique—e.g., the NN-detector module 110 is configured to implement a YOLO object detection technique to identify an object as an object of interest. The NN-detector module 110 can apply the classification technique(s) to one or more data structures within a trained dataset stored in memory 104. The classification technique(s) can be applied to the or data structure(s) in a serial manner, in a parallel manner, in an iterative manner, in a recursive manner, etc.

The processor 102 can include a light informed shape analysis (LISA) module 112. The LISA module 112 can be configured to scan an image scene to identify one or more objects. For instance, the LISA module 112 can be configured to receive one or more images scenes from the input module 106. The LISA module 112 can be programmed to use one or more image processing techniques (e.g., image segmentation, image compression, morphology, object detection, feature extraction, image recognition, pattern recognition, projection, elastic shape analysis, Gabor filtering, liner filtering, etc.) to determine that one or more objects is present in the image scene. For instance, the LISA module 112 can be configured to identify an object, one or more shape contour(s) associated with the object, etc. using a shape analysis technique (e.g., elastic shape analysis). As a non-limiting example, the LISA module 106 can be configured to use elastic shape analysis to extract features that define one or more shape contours of one or more object(s) that have or are being identified, classified, and/or tracked by the NN-detector module 110.

As explained in more detail herein, the shape analysis technique can include a scale factor metric that is representative of an object of interest's size in relation to the image scene. This scale factor can be used to distinguish between contour(s) from a shape that is an object and contour(s) from a shape that is a replica. For instance, extracting contour(s) from a truck and those from a toy truck might confuse the LISA module 112 as thinking that the contour(s) are from the same object, but the scale factor can be used to allow the LISA module 112 to distinguish the contours(s) from the two—e.g., the scale factor can allow the LISA module 112 to determine that a first set of contour(s) is from the truck and the second set of contours is from the toy truck.

These shape contour(s) can be processes in streaming format, further processes (e.g., tagged, encoded, etc.) before being processed, stored in memory, segmented as long-term memory or short-term memory and stored in a library, or any combination of the above. For instance, the processor 102 can be configured to cause the LISA module 112 to extract one or more shape contours of one or more objects of the image scene and store the one or more shape contours in a data library 114. The processor 102 can be configured to cause the LISA module 112 to generate at least one or more of a short term shape contour data set 116 or a long term shape contour data set 118 within the data library 114. These shape contour(s) can be used for object detection, classification, and/or tracking. For instance, the long term shape contour data set 118 can be shape contour data being extracted by the LISA module 112 from objects being tracked by the NN-detector module 110. When the NN-detector module 110 drops a bounding box for an object being tracked, the LISA Module 118 can pull from the long term contour data set 118 to begin its operations (e.g., extracting a region of interest, etc.) for the object whose bounding box had been dropped. For implementing a tracking function, the LISA module 118 can begin generating a short term shape contour data set 116 for that object. Once the NN-detector module 110 can re-establish the bonding box for the object, the system 100 can engage in data management schemes to determine if/how/when to purge the short term shape contour data set 116, if/how/when to purge the long term shape contour data set 118, etc.

The dataset(s) 116, 118 in the data library 114 can include labeled images of an averaged representation of image classes in which objects from an image scene had been extracted via a shape analysis technique (e.g., clastic shape analysis (ESA)). While details of how the dataset can be generated via ESA are presented below in the “examples” section of the disclosure, an overview of an exemplary technique for doing so is provided in this paragraph. Labeled images of an averaged representation of image classes can be generated as statistical data from pixels present in the extracted contour(s) that were used to generate an averaged representation of an actual object and/or what constitutes a typical shape of an expected object. With this representation, a distance between a curve of a perimeter of the shape of interest of the object and a curve of a perimeter of a reference shape (e.g., an actual shape and/or an expected shape) can be quantified. A measure of distance between the curve of the perimeter of the shape of interest of the object and the curve of the perimeter of the reference shape can then be determined. A Riemannian metric and a Square Root Velocity function can be used to quantify the distance. A path straightening technique can be used to determine that the shape of interest matches the reference shape. This exemplary method can be used to generate the short term and/or long term dataset(s) 116, 118, which can be stored in the data library 114.

With access to this/these dataset(s) 116, 118, the LISA module 112 can classify one or more of the objects within the expected region of interest. As a non-limiting example, a Riemannian-manifold framework can be applied to a set of geodesics to identify and preserve properties that define a shape as it is altered in size, rotated, and/or translated. This can be done to model variations among detected shapes, quantify differences among shapes, and classify shapes by projecting a shape onto a manifold. For instance, the Riemannian-manifold framework can be configured as a metric that measures a combination of stretching and bending to optimally deform one curve into another. The Riemannian-manifold framework can then be via a square root velocity function (SRVF) and a path straightening algorithm (PSA). The SRVF can quantify distances between two curves (e.g., a test curve and a reference curve), each curve being a curve on a perimeter of a shape. The PSA can be configured as an iterative optimization algorithm that uses gradient descent on the space of all continuous paths that begin at the SRVF. The PSA can be configured to find a minimum geodesic path between the test curve and the reference curve. The PSA can be configured to perform this iteratively, wherein the summation of iterations of a certain path length can be used to represent a PSA score. The PSA score can be used to determine how close the test curve is to the reference curve. For instance, the algorithm can be configured such that the smaller the PSA score, the more similar the test curve is to the reference curve. This PSA algorithm can be performed one or more times and for one or more test curves for a given reference curve. The result can be a classification of an object based on the shape. The classification can be used to generate labeled images using an averages representation of image classes.

In an exemplary implementation, the processor 102 can be configured to receive one or more image scenes. This can include receiving an image scene from the image capture device 108. The processor 102 can be configured (e.g., programmed) to cause the NN-detector module 110 to perform one or more functions disclosed herein. For instance, the processor 102 can be configured to cause the NN-detector module 110 to scan the image scene to identify an object as an object of interest. The processor 102 can be configured to cause the NN-detector module 110 to identify a region of interest for the object of interest. The processor 102 can be configured to cause the NN-detector module to generate a bounding box that encompasses the object of interest and the region of interest. The processor 102 can be configured to cause the NN-detector module to track position or movement of the object of interest. Identifying an object of interest can be achieved by comparing scanned object(s) with objects in a trained data set using mathematical model(s) (regression, multivariable analysis, etc.), artificial intelligence, etc., and selecting a best match, for example. The regions of interest and generation of bounding boxes for the same can be determined using confidence intervals (as described in more detail below). As the images of the image scene are received, successive bounding boxes can be generated for tracking purposes based on confidence intervals—e.g., if the object is moving, successive bounding boxes can be generated for the object. The position of the bounding box (and the object of interest bounding therein) can be determined by using pixel coordinates of the image, for example. Exemplary processes for these functions are discussed below.

If the NN-detector module 110 never dops the bounding box for the object of interest, the processor 102 can be configured to continue to allow the NN-detector module 110 to identify/classify/track objects from the image scene.

If/when the NN-detector module 110 drops the bounding box for the object of interest, the processor 102 can be configured to cause the LISA module 112 to extract one or more regions of interest. This extracted region of interest can be used as an expected region of interest for the object of interest—e.g., the bounding box had been dropped, so the extracted region of interest is what is expected or predicted to be what/where the bounding box would have been if the NN-detector module 110 did not drop the bounding box. This can be done using predictive techniques (e.g., regression for example). As noted herein, the LISA module 112 can be working in the background as the NN-detector module 110 is operating. For instance the LISA module 112 can be working in the background to extract one or more shape contour(s) of object(s) being identified/classified/tracked by the NN-detector module 110. The extracted shape contour(s) can be associated (tagged, encoded, etc.) with the object of interest being identified/classified/tracked by the NN-detector module 110. These associated shape contour(s) can be stored in the data library 114 (e.g., may be stored as part of the long term shape contour data set 118, for example). The LISA module 112 can retrieve this data for comparison as needed. Thus, if/when the NN-detector module 110 drops the bounding box for the object of interest and the processor 102 causes the LISA module 112 to extract a region of interest, the LISA module 112 is extracting a region of interest for an object that the LISA module 112 determines is the object of interest for which the bounding box had been dropped based on the extracted shape contour(s) associated with that object.

The processor 102 can be configured to cause the LISA module 112 to extract one or more shape contours of the object of interest (e.g., the object of interest within the extract a region of interest) for use as a representation of the object of interest. This extracted data may be stored in the data library 114 as part of the short term shape contour data set 116, for example. Extracted shape contour(s) can be compared to the shape contour(s) stored in the data library 114 to determine if the currently extracted shape contours match (within a predetermined threshold) those of previously extracted shape contours stored in the data library 114. If a match (e.g., a statistical match) occurs, then the LISA module 112 can identify/classify the object within the extracted region of interest as the object of interest for which the bounding box had been dropped. The LISA module 112 can then generate a bounding box defined by the extracted region of interest to track the object of interest until (or if) the NN-detector module 110 can reestablish its bounding box for the object of interest. If no match occurs, then the LISA module 112 can generate another extract a region of interest in an attempt to find a match, or the LISA module 112 can determine that the object of interest is no longer within the image scene. The number of times the LISA module 112 generates an extracted region of interest, if subsequent extracted regions of interest use different criteria (e.g., different predictive methods, thresholds, etc.), when the LISA module 112 determines that the object of interest is no longer within the image scene, etc. can be determined by design criteria. For instance, an objective or cost function can be used to factor in trade-offs, system requirements, computational resources, etc. If after the predetermine number extracted regions of interest have been generated and no shape contour-object matches have been obtained, the system 100 can determine that the object of interest has disappeared from the image scene. The system 100 can then toggle back to the scanning/detecting/classification/tracking techniques of the NN-detector module 110 (which can include the LISA module 112 working in the background).

It is understood that if/when the NN-detector module 110 dops a bounding box for an object and the LISA module 112 kicks in for that object whose bounding box had been dropped, the NN-detector module 110 may still be tracking other objects within the image scene and the LISA module 112 can be working in the background for those other objects.

As can be appreciated from the above, if/when the bounding box is dropped and the NN-detector module 110 continues to not be able to re-establish the bounding box but the LISA module 112 can identify/detect/classify the object of interest via the extracted contour(s), the processor 102 can be configured to cause the LISA module 112 to track position or movement of the object of interest. The processor 102 can be configured to cause the NN-detector module 110 to continue to scan the image scene while the LISA module 112 tracks position or movement of the object of interest. The processor 102 can be configured to cause the NN-detector module 110 to track position or movement of the object of interest upon re-establishing the bounding box for the object of interest. The processor 102 can be configured to prevent the LISA module from tracking position or movement of the object of interest when the NN-detector module 110 is tacking position or movement of the object of interest.

An exemplary embodiment can relate to a computer vision object detection method. The method can involve receiving an image scene. The method can involve performing one or more functions by a Neural Network based object detector (NN-detector) module 110. The method can involve scanning, by the NN-detector module 110, the image scene to identify an object as an object of interest. The method can involve identifying, by the NN-detector module 110, a region of interest for the object of interest. The method can involve generating, by the NN-detector module 110, a bounding box that encompasses the object of interest and the region of interest. The method can involve tracking, by the NN-detector module 110, position or movement of the object of interest. When the bounding box for the object of interest is dropped, the method can involve performing one or more functions by a light informed shape analysis (LISA) module 112. The method can involve extracting, by the LISA module 112, a region of interest for use as an expected region of interest for the object of interest. The method can involve extracting, by the LISA module 112, one or more shape contours of the object of interest for use as a representation of the object of interest. The method can involve tracking, by the LISA module 112, position or movement of the object of interest.

The method can involve continuing to scan the image scene via the NN-detector module 110 while the LISA module 112 tracks position or movement of the object of interest. The method can involve tracking position or movement of the object of interest by the NN-detector module 110 upon re-establishing the bounding box for the object of interest. The method can involve preventing the LISA module 112 from tracking position or movement of the object of interest when the NN-detector module 110 is tacking position or movement of the object of interest. The method can involve extracting, via the LISA module 112, one or more shape contours of one or more objects of the image scene. The method can involve storing, via the LISA module 112, the one or more shape contours in a data library 114. The method can involve generating, via the LISA module 112, at least one or more of a short term shape contour data set or a long term shape contour data set within the data library 114. The method can involve identifying an object as an object of interest by implementing a YOLO object detection technique. The method can involve extracting one or more shape contours by implementing a shape analysis technique. The method can involve elastic shape analysis as one of the shape analysis techniques. In some embodiments, the shape analysis technique can include a scale factor metric that is representative of an object of interest's size in relation to the image scene.

The system 100 can include processors, computer devices, displays, etc. configured to generate one or more user interfaces. The user interface can be configured to generate an output. The output can be a textual, audio, visual, graphical, etc. output configured to indicate the identification/classification/tracking of objects. For instance, the output can indicate or identify an object as an object of interest and the NN-detector module 110 generated bounding box for that object. The output can illustrate the bounding box around the object of interest as the object moves throughout the image scene. The output can also indicate if/when the bounding box for the object had been dropped, as well as if when the LISA module 112 extracts a region of interest and is able to identify/classify/track the object of interest whose bounding box had been dropped. The output can illustrate the tracking of the object of interest by the LISA module 112 as it moves throughout the image scene. The output can be transmitted to a display, for example, as a signal to cause the display to graphically, digitally, etc. illustrate the above via a user interface, for example.

### EXAMPLES

The following are exemplary systems, methods, and implementations of the embodiments disclosed herein. While the examples may focus on one implementation, it is understood that this is exemplary and the embodiments disclosed herein are not limited thereto.

One of the problems with NN-based object detectors is a problem endemic to deep learning-based object detection models in general. Deep learning puts an enormous amount of trust in the training set to represent all configurations detectable objects within the imagery to be captured will take. While NN-based object detectors' ability to find objects is extremely valuable, NN-based object detectors tends to be “brittle” in the sense that when an object gets obscured by some means or changes its configuration beyond the scope of the confines of the training set, the NN-based object detectors-generated object detection bounding box disappears; thus, generating a false negative in current and (possibly) subsequent video frames.

This phenomenon can be overcome by means of inserting an “adjudicator” based on clastic shape analysis (ESA). The exemplary adjudicator algorithm, which can be referred to herein as LISA or Light Informed Shape Analysis can operate by capturing and scoring the shape of the object contained in a prospective region of interest using only the present illumination on the object. This reliance on nothing more than current illumination in our scene has the effect of dismissing the need for a large and comprehensive training set. LISA can create an object detection score of the object's illumination-defined shape in a prospective ROI by means of aggregating the detected object's illumination-defined shapes that neural network-based object detectors previously captured. This aggregation can occur by using a weighted Karcher mean, and the scoring occurs by using the Path Straightening Algorithm (PSA). Combining LISA with YOLO leads to SOLO or Shapes Only Look Once and ultimately serves to enhance YOLO's inference step. Results presented herein demonstrate SOLO's false-negative mitigating ability for YOLO by considering a series of examples depicting objects that are partially concealed and operating in challenging video acquisition circumstances.

Prevailing neural network (NN)-based computer vision methodology, when applied to object detection, takes training data input, applies a model, and then makes distinctions between the classes of objects within the training set (which we term items-of-interest or IOIs) and those objects who are not members of the training set. A machine learning model's theory of knowledge produces justified beliefs about the class of a particular detected IOI by means of using inference to generate a confidence interval deeming a candidate IOI to be a member of the training classes. When this inference process works well, a true positive is generated where an IOI exists in the image under examination and its existence is detected, localized, and classified. A false negative—which is the focus of this invention's work-occurs when an IOI exists in the image under examination but whose existence is not acknowledged. Fundamentally, since no one has proven that P=NP, it cannot be reasonably postulated that a deterministic, polynomial-time algorithm exists capable of finding all possible configurations of an IOI to be encountered by a computer vision algorithm and thus false negatives will continue to persist.

The importance of mitigating false negatives cannot be understated. Consider that an autonomous vehicle (AV) taxi—reliant upon the inferences made by their object classification models—may not detect pedestrians nearby. This lack of pedestrian-detection permanency will thus endanger pedestrians, an AV's passengers, and the AV itself. Furthermore, mistakes in this domain will lead to a loss of reputation and revenue of the AV taxi's owner. Thus, the existence of a false negative can lead to a massive disruption in a company's operations [1]. Hence, it is of great importance to reduce the occurrences of false negatives and make sure that a detected object remains detected.

Neural network-based object detectors have become well-established as a means of performing object detection and tracking. These detectors do however suffer from the same problems endemic to all forms of deep learning-based networks in the sense that they, too, place an enormous amount of credibility in the training set to provide the various instantiations and configurations of the objects to be detected and classified. The concept behind NN-based object detectors works well in many scenarios, but it is not perfect because there is much that the training set utilized by a NN-based object detector does not cover. There are permutations or levels of concealment for a particular object which simply may not exist in the training set; thus, resulting in a false negative when a novel instance of an object to be detected is encountered. Furthermore, even a well-trained model may drift over time as the information it was trained on becomes outdated when encountering a novel scene.

This invention's contribution asserts that a mathematical technique known as elastic shape analysis (ESA) offers a way forward in the effort to mitigate false negatives in objects tracked over time by NN-based object detectors. ESA does not require any training beyond an abstract notion of what constitutes the shape of an object to be detected. ESA provides a means of performing a direct inquiry into an image to find objects conforming to an expected shape. When ESA is combined with an NN-based object detector's bounding box proposal capability, this affords the ability to enhance NN-based object detectors by filling knowledge gaps in their inference process. As demonstrated herein, embodiments relate to a technique that combines the strengths of two object detection algorithms to enhance their overall performance.

Aspects of the technique can be premised upon the notion that the best training set is physical reality as it is manifested in the illumination placed upon an object. How that lighting is manifested on the object varies over time and thus we accumulate and aggregate the features present as they are illuminated to hold constant the specialness that marks an object as a genuine IOI and not clutter. The technique can score the detected object's aggregated features as an IOI and thus maintain its true positive status. The aggregation step can utilize a weighted Karcher mean [2] (KM) to average the shapes present and a PSA [3] to score the IOI and add or subtract weight to an object's contribution to the KM's feature aggregation. In some embodiments, the combination of these two steps, in conjunction with the scene's illumination, leads to LISA or Light Informed Shape Analysis.

### How YOLO Works

YOLO [4] serves as a canonical representative of the type of NN-based object detector that we seek to improve and thus serves as our foundation for the hybridized algorithm. YOLO performs object detection and classification through a single pass on the image. YOLO subdivides the image under its consideration into an N×N grid where if a given grid tile contains an IOI's centroid, that tile is deemed to hold the IOI. To perform this detection task, each grid tile is searched with a set of proposed bounding boxes and a confidence score is generated indicating the likelihood that an IOI is contained within the bounding box proposal.

During training YOLO can specialize a predictor to concentrate on an IOI's size, aspect ratio, and class which leads to improving YOLO's recall. Another valuable technique is YOLO's use of non-maximum suppression (NMS). NMS allows for the compression of multiple bounding boxes containing the same object into a single bounding box. NMS has the effect of removing redundant bounding boxes and thus focusing on a single bounding box or an IOI.

Embodiments of the techniques disclosed herein focus on YOLO's final bounding box construction step where the predictor makes its final determination regarding the location and dimensions of an object detected. A key thing to consider is that when a bounding box is produced for an object by YOLO, that object may not maintain its feature-expression integrity through all instances of the object in subsequent image frames. In other words, what was correctly detected and classified in frame n may not continue to be detected and classified in frame n+1—hence leading to a removed or “dropped” bounding box and, thus, a false negative. Recalling the inherent brittleness of NNs, this lack of object detection permanency can be explained by the simple fact that the features being expressed in frame n+1 do not match those that YOLO's underlying NN was trained on in frame n.

There have been attempts to improve YOLO in its subsequent versions [5]. Ultimately, however, these improvement techniques rely upon the use of a training set as their foundational effort to make their version viable. This reliance upon ever greater amounts of training data to make a model viable leads to the use of hundreds of thousands of GPUs to process training data in gigantic data centers [6].

The techniques disclosed herein can be thought of a hybridized method. The hybridized method can be premised on the acknowledgement that there are mobile and compute platforms upon which processing and/or data storage may be limited. Therefore, existing systems cannot reasonably count on the circumstances described above to ameliorate YOLO's deficiencies to always prevail. Hence, the technical solution provided by embodiments of the techniques disclosed herein can be thought of as “corrective lenses” to YOLO's operation. The techniques can also and serve as an immediate “plugin” requiring no special or additional hardware enhancements. The inventive technique can mitigate this lack of object permanency by introducing an ability to accept an object's shape inevitable deformations, transformations, and occlusions.

### How ESA Works

To get a meaningful understanding of the objects that populate the images, clastic shape analysis (ESA) can be used [6]. The salient point about ESA is that it allows for a direct inquiry into an image to find objects that conform to the shape of the object that is being searching for. This ability has many powerful implications because it can perform object detection more robust in the face of natural or artificial image corruption.

The two algorithms related to shape analysis that are used with the techniques disclosed herein are the path straightening algorithm (PSA) (as well as its companion augmented path straightening algorithm (APSA)) and a weighted Karcher Mean (WKM). The WKM is responsible for understanding the salient features present in the object's extracted, whereas the (A) PSA is responsible for distinguishing what objects should be selected and added to the WKM.

### How the (A) PSA Works

The concept of ESA has been written about extensively by Srivastava and Klassen [7]. Techniques disclosed herein primarily focus on the so-called path straightening algorithm or PSA of the ESA. This algorithm was first described here [2]. The point of the algorithm is to find the minimal energy path (e.g., the straightest path) that will unite the points of contours representing a reference and a test shape. The amount of energy required to generate and traverse this path indicates the similarity of the two contours. This energy is represented as a path distance score. Using the state of Florida as an example, the PSA would be used to indicate that Florida's shape is more closely associated with the capital letter “L” and further removed from the capital letter “Q”.

The steps of the PSA are given below.
1. Extract contours from an image.
2. Place reference and extracted candidate contours in the square root velocity framework [2].
3. Project contours onto a respective reference and candidate Riemannian manifold [2].
4. Perform diffeomorphic operations to find the lowest energy manifold conformation that aligns the reference and candidate contours [2].
5. Generate a path distance uniting the two manifolds and report this as a similarity score [2].

Note that the concept of a shape as it applies to the use of the PSA is explicit about maintaining agnosticism about the size of the objects to be classified [2]. All contours encompassing shapes of interest in the techniques disclosed herein are scale invariant since they are meant to be compressed to a unit length prior to application of the PSA. However, this agnostic approach—while useful for calculating a score that indicates how (dis) similar two shapes happen to be—can indicate, for example, a toy truck and an actual truck are the same object when, in fact, they are not. When performing a scene analysis such that items of interest are detected and classified, knowledge of scale becomes vitally important since certain candidate shapes will then and therefore be dismissed from consideration because they are not the right size.

Thus, the Augmented Path Straightening Algorithm (APSA) is meant to inject knowledge of what we will call scale weight. Scale weight is measured by comparing a candidate curve's interior area (in square meters) to a reference curve's area. Note that the area of a curve is calculated by multiplying all the pixels encompassed within the curve by the formula: Pixel-Scale =Range*IFOV. The curve area and reference area are computed by simply performing a sum of all pixels contained with the respective contours' perimeters. The formula below is used as a means of altering the final PSA score so that similar, but obviously too large or too small objects are rejected, thus leading to better detection and classification performance.

$$scale weight = 1 + \frac{\vert curve area - reference area \vert}{reference area}$$

The larger the difference between the curve area and the reference area, the greater the modification cost and thus elements which are not the same scale are separated further from each other. As we will see, the application of the APSA algorithm leads to a means of quickly acknowledging the existence of an object which may otherwise have generated a false negative by YOLO.

### How the Karcher Mean/Weighted Karcher Mean Works

The statistical mean can be a geometric mean (e.g., a Karcher mean), a harmonic mean, root mean square mean, etc. It is contemplated for the statistical mean to be a Karcher mean. For instance, the statistical mean can be a geometric mean of several matrices of data points representative of plural actual shapes and/or expected shapes.

The Karcher mean (KM) [1] refers to a method for finding how shapes can be “averaged” together. Of particular interest is how the KM allows for an understanding of the aggregated features that define a detected object's shape. The calculation of the KM uses the same mathematical tools used in the context of calculating the outcome of the PSA. The KM relies upon resolving the outcome of an optimization algorithm such that the minimum distance is found amongst the prospective shapes that occupy a given class. The KM's point is to find a minimizing geodesic such that a path distance is minimized between a reference chosen from a class and all other candidate members within that class.

What this algorithm's operation means in actual practice is that the averaged shapes produced will have similarities consistent with other members of the shape class. Wildly different shapes may be incorporated into the KM, and the algorithm will attempt to “smooth” out these different shapes such that they are consistent with the other members of the original reference class. Of particular interest is what defines the “essentials” in each shape class-hence the fine details that mark an object are made irrelevant because they are smoothed away.

Maintaining these shape class essentials is where the weighted Karcher mean (WKM) becomes valuable. What makes the WKM distinctive is its maintenance of shape class consistency by considering only those shapes that are admissible and discounting those who are not. Candidate contours are placed in a queue called the WKMQ whose size is preset by the user. A shape which is deemed “admissible” to the WKMQ has the following properties:
1. There is an acceptable distance proximity with the previously acquired contours.
2. There is an acceptable APSA score comparing a prospective contour with members of the WKMQ, and the last element admitted to the WKMQ.

Should a prospective contour seeking admission into the WKMQ not conform to any of the above criteria it is dismissed, and another peer contour is evaluated. This conformity ensures that when the LISA algorithm is applied, object detection permanency is maintained.

Combining YOLO with LISA to Produce SOLO

### Combining ESA Concepts to Produce LISA

The beauty of the ESA-related algorithms is that they can each operate as standalone algorithms who's only training necessities are a reference contour in the case of APSA or at least two contours in the case of the WKM. The origin of these contour references can be from algorithmic generation, a human-drawn outline, or in our case, from a contour extractor performing a carve out of illuminated areas in an image. This flexibility in the training origin allows for multiple means of understanding objects within an image.

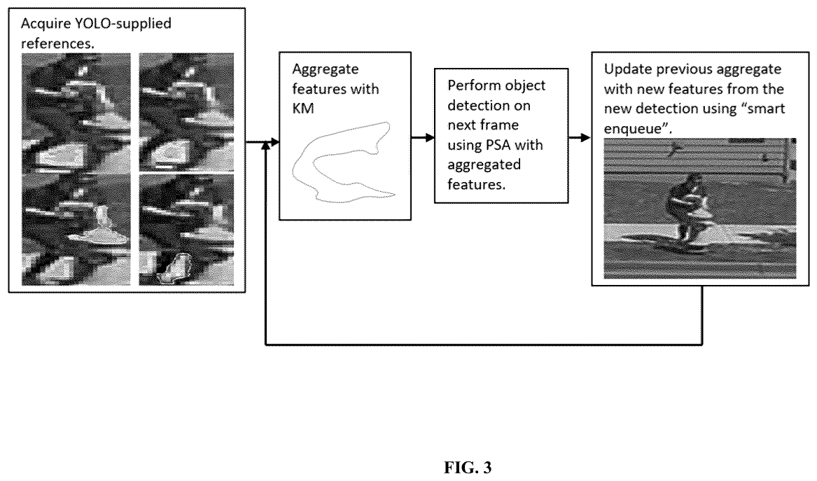

Referring to FIG. 3, the focus can then be on how a contour extractor can be utilized for the purpose of producing a contour from an illuminated object. This is significant because no presumptions need be made about the shape the object will take once the extraction takes place; the shape extracted need not be anything resembling what a human would presume it to be—the system is only guided only by what the image's light source reveals. For example, if the interest is detecting a stop sign and only the upper corner of the stop sign is revealed and its contour extracted, that is sufficient for the LISA algorithm to operate.

The “smart enqueue” mentioned above entails scoring (and thus weighting) how similar a candidate member of our KM aggregate is to what was previously observed while discounting the deviations that can occur in an observation due to changes in camera angle and jitter. This smart enqueue method has the effect of maintaining the geometric invariance of the object's illumination-revealed shape while understanding that lighting upon the object will change as time (and frames) progress.

Where LISA Can be Incorporated into YOLO to Produce SOLO

Making the LISA algorithm work with YOLO to produce SOLO is a matter of performing the following steps.
1. At frame n collect the largest contour of the object contained within the bounding box generated by YOLO.
2. Place this reference contour in a queue called the WKMQ.
3. If queue is filled, perform KM averaging on the queue's contours.
4. At frame n+1
5. If YOLO bounding box as present, dequeue the first contour in the WKMQ and then enqueue the next extracted contour.
6. If the YOLO bounding box is not present:
   6.1. While YOLO bounding boxes are not presented:
      6.1.1. Extract a region of interest approximating the location of where the YOLO bounding box would be.
      6.1.2. Extract contours within the ROI; place contours within a table data structure.
      6.1.3. Filter contours based on expected size of object to be detected; size is inferred by average of previously detected objects or is preset.
      6.1.4. Calculate distances of contour centroids relative to the location of the previously detected contour.
      6.1.5. Perform PSA using filtered table-members as candidates and KM-averaged contours as the reference.
      6.1.6. Weight contours with a better score than further objects
      6.1.7. Select best-scoring contour from table and designate this as detected object.
      6.1.8. If the best-scoring contour is not radically different from immediately previous detected contour, perform WKMQ enqueue with selected contour.
      6.1.9. Else, get the PSA score for the selected candidate by comparing it with the KM and the immediate precedent contour.
         6.1.9.1. Select the object-detection contour using the following criteria: best score relative to immediate predecessor, best score relative to the KM, and closest to immediate predecessor.
         6.1.9.2. Selected contour is based on best out of three categories.
         6.1.9.3. If no winner, flag a non-detection.

### Results

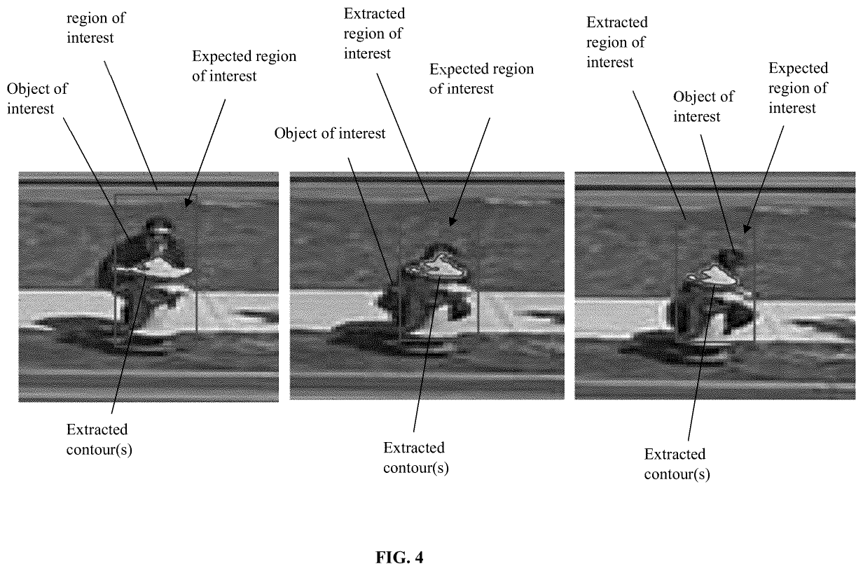

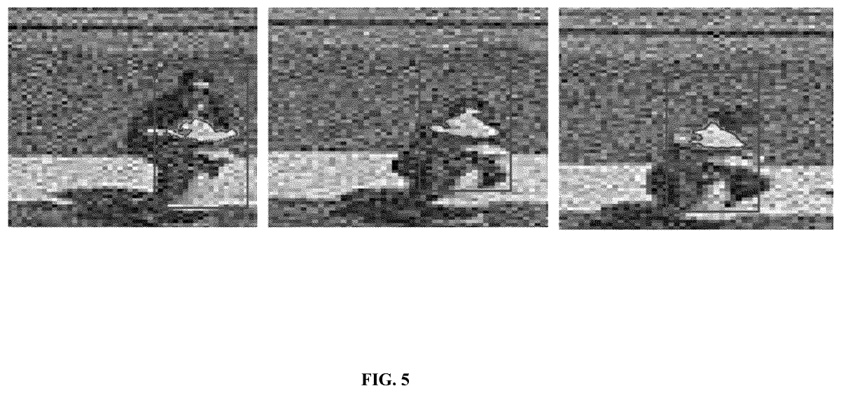

Referring to FIGS. 4-5, evidence of LISA (and thus SOLO's) success is demonstrated for a case in which it was applied to images where a person is partially concealed behind a fire hydrant. These images were acquired under clean and noisy conditions. The contours represent the output of LISA whereas the bounding boxes represent the preservation of YOLO's last known bounding box (prior to being dropped) centered on the contour. FIGS. 4-5 show instances of preserving object detection permanency in the presence of confounding factors that would disrupt YOLO and thus prove the efficacy of LISA in “filling the gap” in YOLO's inference step.

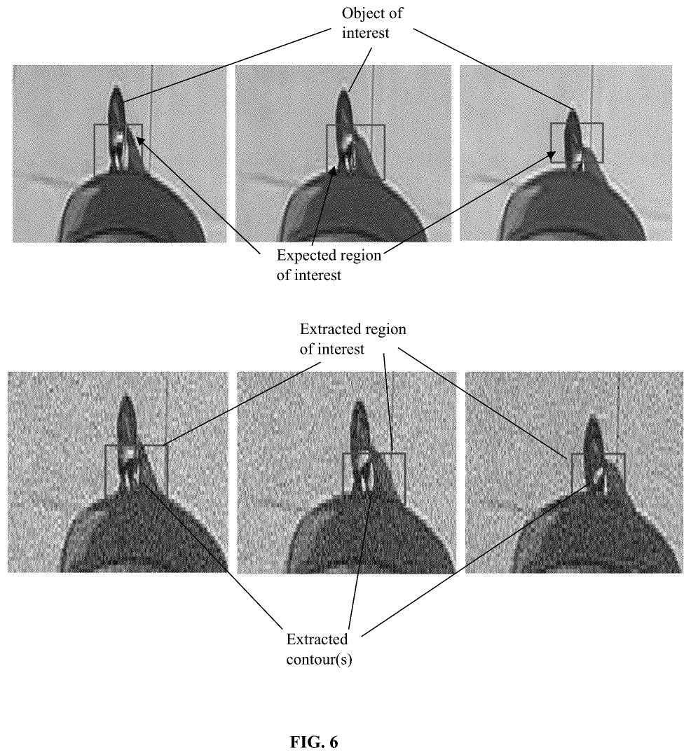

FIG. 6 demonstrates LISA's (and thus SOLO's) ability to detect a person engaged in deliberate concealment behind a car in both noisy and clean conditions. The bounding box overlay strategy we described above is maintained here as well. A similar conclusion may be drawn in the sense that LISA serves to “fill the gap” in YOLO's inference process even in when encountering imperfect imaging conditions.

### CONCLUSION

Techniques disclosed herein address a fundamental problem in NN-based object detectors, namely, that they are limited by the amount of information contained in their training sets and cannot operate effectively in conditions which extend beyond what they have been trained on. While these limitations are prominent, they can be overcome by being cognizant of the information that is present in the image which might otherwise have been overlooked by the NN's model. Reliance on direct inquiries into the image to extract object detection contours affords the flexibility necessary to overcome challenging object detection scenarios that would utterly confuse an NN-based object detector.

### REFERENCES

The following references are incorporated herein by reference in their entireties.
[1] A. Marshall, GM's Cruise Halts All US Robotaxi Service After Suspension for Pedestrian Who Was Dragged, GM's Cruise Halts All US Robotaxi Service After Suspension for Pedestrian Who Was Dragged | WIRED (accessed Aug. 27, 2024).
[2] S. Kurtek, “Riemannian Shape Analysis of Curves and Surfaces”, Ph.D. dissertation, Dept. of Statistics, Florida State University, Tallahassee, 2012.
[3] A Srivastava, E. Klassen, S. Joshi, and I Jermym, “Shape analysis of elastic curves in Euclidean spaces”, IEEE Transactions on Pattern Analysis and Machine Intelligence, vol. 33 (7), pp. 1415-1428 July 2011.
[4] J. R. Terven and D. M. Cordova-Esparaza, A Comprehensive Review of YOLO: from YOLO v1 to YOLO v8 and Beyond, https://arxiv.org/pdf/2304.00501v1, 2023.
[5] J. Torres, YOLOv8 Improvements: Exploring Key Architectural Enhancements, YOLOv8 Improvements: Key Architectural Enhancements (accessed Aug. 27, 2024).
[6] D. Grimm, Elon Musk's liquid-cooled ‘Gigafactory’ AI data centers get a plug from Supermicro CEO—Tesla and xAl's new supercomputers will have 350,000 Nvidia GPUs, both will be online within months, Elon Musk's liquid-cooled ‘Gigafactory’ AI data centers get a plug from Supermicro CEO—Tesla and xAl's new supercomputers will have 350,000 Nvidia GPUs, both will be online within months | Tom's Hardware (tomshardware.com) (accessed Aug. 27, 2024).
[7] A. Srivastava and E. Klassen, Functional and Shape Data Analysis, Springer, 2016.

It will be understood that modifications to the embodiments disclosed herein can be made to meet a particular set of design criteria. For instance, any of the components, features, or steps of the system, apparatus, or method can be any suitable number or type of each to meet a particular objective. Therefore, while certain exemplary embodiments of the systems and methods disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A computer vision object detection system, the system comprising:
a processor including a Neural Network based object detector (NN-detector) module and a light informed shape analysis (LISA) module, wherein the processor is configured to:
receive an image scene;
cause the NN-detector module to:
scan the image scene to identify an object as an object of interest;
identify a region of interest for the object of interest;
generate a bounding box that encompasses the object of interest and the region of interest; and
track position or movement of the object of interest;
when the NN-detector drops the bounding box for the object of interest, cause the LISA module to:
extract a region of interest for use as an expected region of interest for the object of interest;
extract one or more shape contours of the object of interest for use as a representation of the object of interest; and
track position or movement of the object of interest.

2. The computer vision object detection system of claim 1, wherein:
the processor is configured to cause the NN-detector module to continue to scan the image scene while the LISA module tracks position or movement of the object of interest.

3. The computer vision object detection system of claim 2, wherein:
the processor is configured to cause the NN-detector module to track position or movement of the object of interest upon re-establishing the bounding box for the object of interest.

4. The computer vision object detection system of claim 3, wherein:
the processor is configured to prevent the LISA module from tracking position or movement of the object of interest when the NN-detector module is tacking position or movement of the object of interest.

5. The computer vision object detection system of claim 1, wherein:
the processor is configured to cause the LISA module to extract one or more shape contours of one or more objects of the image scene and store the one or more shape contours in a data library.

6. The computer vision object detection system of claim 5, wherein:
the processor is configured to cause the LISA module to generate at least one or more of a short term shape contour data set or a long term shape contour data set within the data library.

7. The computer vision object detection system of claim 1, wherein:
the NN-detector module is configured to implement a YOLO object detection technique to identify an object as an object of interest.

8. The computer vision object detection system of claim 1, wherein:
the LISA module is configured to implement a shape analysis technique to extract one or more shape contours.

9. The computer vision object detection system of claim 8, wherein:
the shape analysis technique includes elastic shape analysis.

10. The computer vision object detection system of claim 8, wherein:
the shape analysis technique includes a scale factor metric that is representative of an object of interest's size in relation to the image scene.

11. A computer vision object detection method, the method comprising:
receiving an image scene;
performing the following by a Neural Network based object detector (NN-detector) module:
scan the image scene to identify an object as an object of interest;
identify a region of interest for the object of interest;
generate a bounding box that encompasses the object of interest and the region of interest; and
track position or movement of the object of interest;
when the bounding box for the object of interest is dropped, performing the following by a light informed shape analysis (LISA) module:
extract a region of interest for use as an expected region of interest for the object of interest;
extract one or more shape contours of the object of interest for use as a representation of the object of interest; and
track position or movement of the object of interest.

12. The computer vision object detection method of claim 11, comprising:
continuing to scan the image scene via the NN-detector module while the LISA module tracks position or movement of the object of interest.

13. The computer vision object detection method of claim 12, comprising:
tracking position or movement of the object of interest by the NN-detector module upon re-establishing the bounding box for the object of interest.

14. The computer vision object detection method of claim 13, comprising:
preventing the LISA module from tracking position or movement of the object of interest when the NN-detector module is tacking position or movement of the object of interest.

15. The computer vision object detection method of claim 1, comprising:
extracting, via the LISA module, one or more shape contours of one or more objects of the image scene; and
storing, via the LISA module, the one or more shape contours in a data library.

16. The computer vision object detection method of claim 15, comprising:
generating, via the LISA module, at least one or more of a short term shape contour data set or a long term shape contour data set within the data library.

17. The computer vision object detection method of claim 11, wherein:
identifying an object as an object of interest is performed by implementing a YOLO object detection technique.

18. The computer vision object detection method of claim 11, wherein:
extracting one or more shape contours is performed by implementing a shape analysis technique.

19. The computer vision object detection method of claim 18, wherein:
the shape analysis technique includes elastic shape analysis.

20. The computer vision object detection method of claim 18, wherein:
the shape analysis technique includes a scale factor metric that is representative of an object of interest's size in relation to the image scene.
